(19) United States
(12) Patent Application Publication
(10) Pub. No.: US 2011/0139406 A1
(43) Pub. Date: Jun. 16, 2011

(54) Pet Cooling Bed

(75) Inventor: Peter Rizzo, Destrehan, LA (US)

(73) Assignee: K9 Necessity, LLC, Harahan, LA (US)

(21) Appl. No.: 13/034,700

(22) Filed: Feb. 24, 2011

(51) Int. Cl. A01K 29/00; F28D 15/00

(52) U.S. Cl. 165/104.19

(57) ABSTRACT

Example embodiments of the pet cooling systems disclosed herein utilize heat transfer properties of water or other fluid in a top layer for holding a supply of water. The example embodiments herein increase the heat transfer properties of the water-filled layer by adding a second layer with an additional heat transfer device that serves to extend the length of time that the water-filled layer is effective in accomplishing heat transfer from the animal laying on the layer. A first top layer is configured to receive water or some other suitable fluid that operates to transfer heat away from the animal laying on the top layer. A second bottom layer is configured to receive a heat transfer device to transfer heat from the water in the first top layer, keeping the water cooler and allowing for more efficient transfer of heat from the animal in contact with the top layer.

### TECHNICAL FIELD

The present disclosure is generally related to cooling animals and, more particularly, is related to a bed configured to cool animals.

### BACKGROUND

Heat stroke is a serious problem for humans and pets. Many dogs are exposed to high temperature environments and may have difficulty dealing with the heat. Ensuring she doesn't overheat is important for the active, outdoor canine. Heatstroke occurs when normal body mechanisms cannot keep the body's temperature in a safe range. Animals do not have efficient cooling systems (like humans who sweat) and may get easily overheated. A dog with moderate heatstroke (body temperature from 104° to 106° F.) can recover within an hour if given prompt first aid and veterinary care (normal body temperature is 100-102.5° F.). Severe heatstroke (body temperature over 106° F.) can be deadly and immediate veterinary assistance is needed. When humans overheat we are able to sweat in order to cool down. However, a dog cannot sweat as easily; he must rely on panting to cool down. Dogs breathe in through the nose and out through the mouth, directing the air over the mucous membranes of the tongue, throat and trachea to facilitate cooling by evaporation of fluid. Your dog also dissipates heat by dilation of the blood vessels in the surface of the skin in the face, ears and feet. When these mechanisms are overwhelmed, hyperthermia and heat stroke usually develop.

Many attempts have been made to assist dogs and other animals in cooling down. For example, one cooling system includes a water pump which circulates water through a mat. However, this system requires batteries and the pump is bulky to transport. Another example system is a mat that holds water. Some mats are simply bags that hold water, and others include foam to hold the water. However, the heat transfer properties of the water in these mat systems are limited. There are heretofore unaddressed needs with previous solutions.

### SUMMARY

Example embodiments of the present disclosure provide pet cooling beds. Briefly described, in architecture, one example embodiment of the pet cooling bed, among others, can be implemented as follows: a first top layer configured to hold a fluid; and a second bottom layer configured to contain at least one heat transfer device for transferring heat from the fluid.

Embodiments of the present disclosure can also be viewed as methods for providing a pet cooling bed. In this regard, one embodiment of such a method, among others, can be broadly summarized by the following steps: providing a first top layer configured to be filled with a fluid; and providing a second bottom layer configured to accept a heat transfer device.

### BRIEF DESCRIPTION OF THE DRAWINGS

FIG. 1 is a top perspective view of an example embodiment of a pet cooling bed.

FIG. 2 is a side perspective view of an example embodiment of the pet cooling bed of FIG. 1.

FIG. 3 is a top perspective view of an example embodiment of the pet cooling bed of FIG. 1 with openings in the bottom layer.

FIG. 4 is cut out view of an example embodiment of the pet cooling bed of FIG. 1.

FIG. 5 is flow diagram of an example embodiment of providing an animal cooling device.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Example embodiments of the pet cooling systems disclosed herein offer an improved solution to the pet cooling systems of the prior art. Many of the previous solutions simply offer a device to hold water, where the water transfers the heat from the animal. Some previous solutions offer a means to circulate the water thereby increasing the heat transfer properties of the water. Example embodiments of the pet cooling systems disclosed herein utilize the heat transfer properties of water or other suitable fluid with a top layer for holding a supply of water. The example embodiments herein increase the heat transfer properties of the water-filled layer by adding a second layer with an additional heat transfer device that serves to extend the length of time that the water-filled layer is effective in accomplishing heat transfer from the animal laying on the top layer.

A first top layer is configured to receive water or some other suitable fluid that operates to transfer heat away from the animal laying on the top layer. In an example embodiment, a first sealable opening is provided to facilitate filling the first layer with the water. A second sealable opening may be provided for evacuation of air as the top layer is filled. The second sealable opening will also facilitate quicker draining when the first layer is emptied.

An example embodiment of the first top layer comprises connected compartments arranged in the various configurations. They may be arranged as length-wise compartments, width-wise compartments, compartments configured in a particular pattern, or randomly arranged compartments. The pattern may be configured in a arrangement designed by an end user, for example, to form a company logo. In the embodiments with the connected compartments, a single opening may be used to substantially fill the entire first top layer. In an alternative embodiment, the compartments are separately fillable. Each compartment has at least one sealable opening to fill the compartment with water or other suitable fluid. This feature allows for continued use should one of the compartments be punctured or rendered unusable. The first top layer may alternatively be a single compartment. In an alternative embodiment, the top layer comprises at least two connected compartments that are separated in the middle of the top layer. This configuration allows for ease in folding the bed in half for carrying. The top layer may be constructed with vinyl or other materials that are not liquid permeable and are suitable for holding shape and the weight of the animal. The bed may be constructed in many different shapes and sizes depending on the size of the animal, among other factors.

The second bottom layer is configured to receive a heat transfer device to transfer heat from the water in the first top layer, keeping the water cooler and allowing for more efficient transfer of heat from the animal in contact with the top layer. The heat transfer device may comprise one or more of an ice pack, a gel pack, a refrigerant gel pack, and an endothermic reactive device. In an example embodiment, the second layer comprises at least one opening configured to receive the heat transfer device. The opening may be left open for ease in insertion and removal of the heat transfer device. In other embodiments, the opening in the second layer is sealable. Example means for sealing the opening include, but are not limited to, a zipper, a slider lock, a zip lock, buttons, snaps, and hook and loop, among others. In an alternative embodiment, the heat transfer device may be integrated into the second layer. In this embodiment, the entire bed may be placed in a freezing device to freeze the heat transfer device. In yet another embodiment, the second layer may be separable from the top layer, and the second layer may be chilled before reattaching to the top layer. The attachment means for the second layer to the top layer may include, as non-limiting examples, at least one of a zipper, a slider lock, a zip lock, buttons, snaps, and hook and loop, among others.

In an example embodiment, the second layer may include a protective layer configured between the heat transfer device and the ground. The protective layer, as a non-limiting example, may be constructed of foam to separate the heat transfer device from the ground. The foam layer may be encapsulated. A protective layer may also be included between the top layer and the bottom layer in an alternative embodiment.

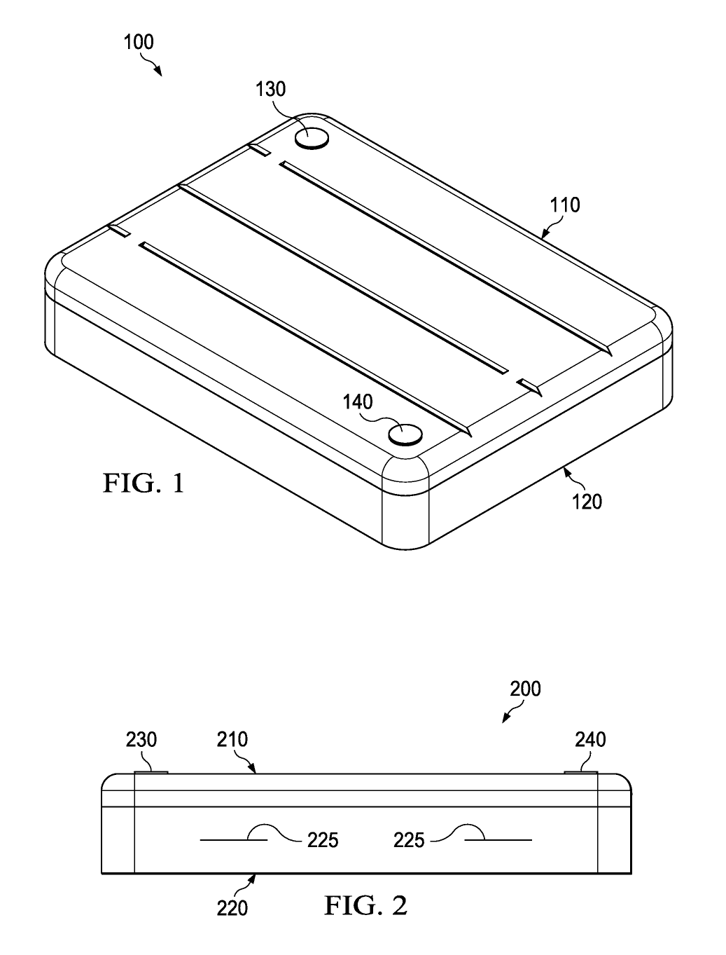

FIG. 1 provides an example embodiment of pet cooling bed 100 as disclosed herein. Pet cooling bed 100 comprises top layer 110, bottom layer 120, first sealable opening 130, and second sealable opening 140. Top layer 110 is configured to receive water or some other suitable fluid that works to transfer heat away from the animal laying on top layer 110. In an example embodiment, first sealable opening 130 is provided to facilitate filling first layer 110 with water. Second sealable opening 140 may be provided for evacuation of air as top layer 110 is filled through first sealable opening 130. Second sealable opening 140 will also facilitate quicker draining when the first layer is emptied. In an example embodiment, second sealable opening 140 is smaller than first sealable opening 130.

An example embodiment of first top layer 110 comprises connected compartments arranged in the various configurations. They may be arranged as length-wise compartments as provided in FIG. 1; but they may also be arranged as width-wise compartments, compartments configured in a particular pattern, or randomly arranged compartments. The pattern may be configured in a arrangement designed by an end user, for example, to form a company logo. In the embodiments with the connected compartments, first sealable opening 130 may be used to substantially fill top layer 110. In an alternative embodiment, the compartments are separately fillable. In this alternative embodiment, each compartment has at least one sealable opening to fill the compartment with water or other suitable fluid. This feature allows for continued use of the bed should one of the compartments be punctured or rendered unusable. Top layer 110 may alternatively be a single compartment. In an alternative embodiment, top layer 110 comprises at least two connected compartments that are separated in the middle of top layer 110. This configuration allows for ease in folding bed 100 in half for carrying. Top layer 110 may be constructed with vinyl or other materials that are not liquid permeable and are suitable for holding shape and the weight of the animal.

Bottom layer 120 is configured to receive a heat transfer device to transfer heat from the water in top layer 110, keeping the water cooler and allowing for more efficient transfer of heat from the animal in contact with top layer 110. The heat transfer device may comprise one or more of an ice pack, a gel pack, a refrigerant gel pack, and an endothermic reactive device.

FIG. 2 provides a side perspective view of pet cooling bed 200. Pet cooling bed 200 comprises top layer 210, bottom layer 220, first sealable opening 230, second sealable opening 240, and at least one opening 225. Pet cooling bed 200 may contain multiple openings 225 to facilitate the insertion and removal of the heat transfer device(s). In an example embodiment, second layer 220 comprises at least one opening 225 configured to receive the heat transfer device. Opening 225 may be left open for ease in insertion and removal of the heat transfer device. In other embodiments, opening 225 in second layer 220 is sealable. Example means for sealing opening 225 include, but are not limited to, a zipper, a slider lock, a zip lock, buttons, snaps, and hook and loop, among others. In an alternative embodiment, the heat transfer device may be integrated into second layer 220. In this embodiment, bed 200 may be placed in a freezing device to freeze the heat transfer device. In yet another embodiment, second layer 220 may be separable from top layer 210, and second layer 220 may be chilled or frozen before reattaching to top layer 210. The attachment means for second layer 220 to top layer 210 may include, as non-limiting examples, at least one of a zipper, a slider lock, a zip lock, buttons, snaps, and hook and loop, among others.

In an example embodiment, second layer 220 may include a protective layer configured between the heat transfer device and the ground. The protective layer, as a non-limiting example, may be constructed of foam to separate the heat transfer device from the ground. The foam layer may be encapsulated. A protective layer may also be included between top layer 210 and bottom layer 220 in an alternative embodiment. Second layer 220 may be constructed with vinyl or other materials that are suitable for holding the heat transfer device.

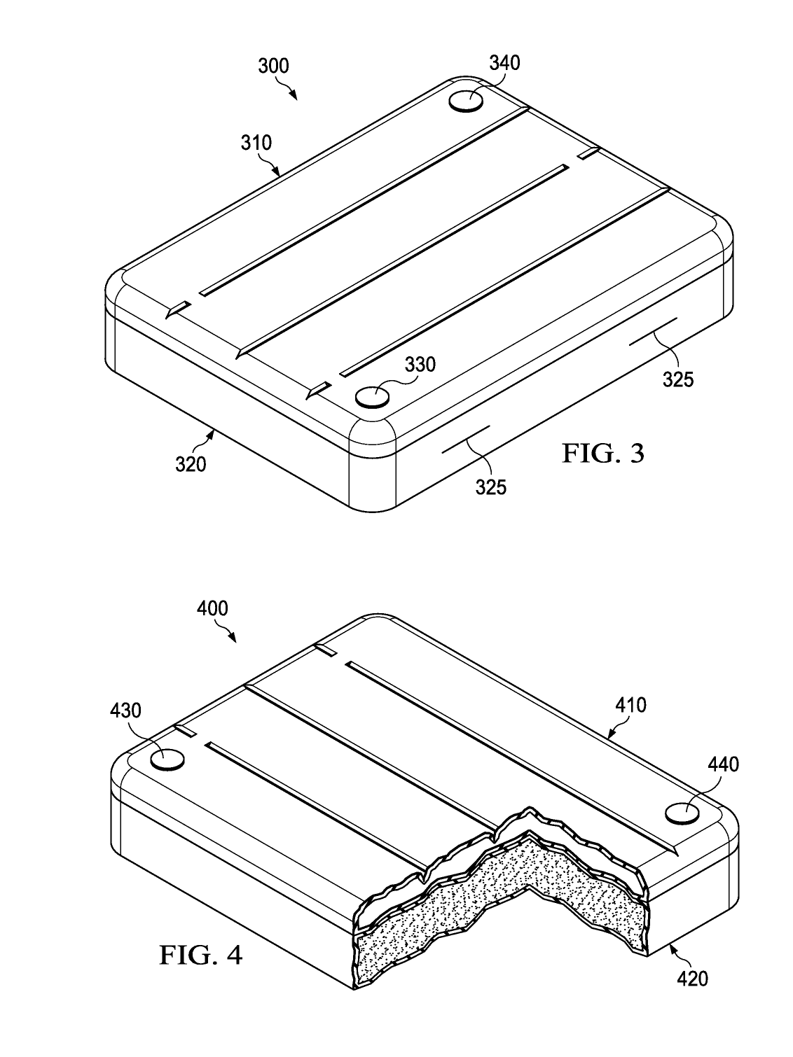

FIG. 3 provides a top view of pet cooling bed 300 with top layer 310, bottom layer 320, first sealable opening 330, second sealable opening 340, and at least one opening 325 in bottom layer 320. Top layer 310 is configured to receive water or some other suitable fluid that works to transfer heat away from the animal laying on top layer 310. In an example embodiment, first sealable opening 330 is provided to facilitate filling first layer 310 with the water. Second sealable opening 340 may be provided for evacuation of air as top layer 310 is filled through first sealable opening 330. Second sealable opening 340 will also facilitate quicker draining when the first layer is emptied.

An example embodiment of first top layer 310 comprises connected compartments arranged in the various configurations. They may be arranged as length-wise compartments as provided in FIG. 3; but they may also be arranged as width-wise compartments, compartments configured in a particular pattern, or randomly arranged compartments. The pattern may be configured in a arrangement designed by an end user, for example, to form a company logo. In the embodiments with the connected compartments, first sealable opening 330 may be used to substantially fill top layer 310. In an alternative embodiment, the compartments are separately fillable. In this alternative embodiment, each compartment has at least one sealable opening to fill the compartment with water or other suitable fluid. This feature allows for continued use of the bed should one of the compartments be punctured or rendered unusable. Top layer 310 may alternatively be a single compartment. In an alternative embodiment, top layer 310 comprises at least two connected compartments that are separated in the middle of top layer 310. This configuration allows for ease in folding bed 300 in half for carrying. Top layer 310 may be constructed with vinyl or other materials that are not liquid permeable and are suitable for holding shape and the weight of the animal.

Bottom layer 320 is configured to receive a heat transfer device to transfer heat from the water in top layer 310, keeping the water cooler and allowing for more efficient transfer of heat from the animal in contact with top layer 310. The heat transfer device may comprise one or more of an ice pack, a gel pack, a refrigerant gel pack, and an endothermic reactive device. In an example embodiment, second layer 320 comprises at least one opening 325 configured to receive the heat transfer device. Opening 325 may be left open for ease in insertion and removal of the heat transfer device. In other embodiments, opening 325 in second layer 320 is sealable. Example means for sealing opening 325 include, but are not limited to a zipper, a slider lock, a zip lock, buttons, snaps, and hook and loop, among others. In an example embodiment, second layer 320 may include a protective layer configured between the heat transfer device and the ground. The protective layer, as a non-limiting example, may be constructed of foam to separate the heat transfer device from the ground. The foam layer may be encapsulated. A protective layer may also be included between top layer 310 and bottom layer 320 in an alternative embodiment.

FIG. 4 provides a cut out view of pet cooling bed 400. Pet cooling bed 400 includes top layer 410, bottom layer 420, first sealable opening 420, and second sealable opening 440. Top layer 410 is configured to receive water or some other suitable fluid that works to transfer heat away from the animal laying on top layer 410. In an example embodiment, first sealable opening 430 is provided to facilitate filling first layer 410 with the water. Second sealable opening 440 may be provided for evacuation of air as top layer 410 is filled through first sealable opening 430. Second sealable opening 440 will also facilitate quicker draining when the first layer is emptied.

An example embodiment of first top layer 410 comprises connected compartments arranged in the various configurations. They may be arranged as length-wise compartments as provided in FIG. 4; but they may also be arranged as width-wise compartments, compartments configured in a particular pattern, or randomly arranged compartments. The pattern may be configured in a arrangement designed by an end user, for example, to form a company logo. In the embodiments with the connected compartments, first sealable opening 430 may be used to substantially fill top layer 410. In an alternative embodiment, the compartments are separately fillable. In this alternative embodiment, each compartment has at least one sealable opening to fill the compartment with water or other suitable fluid. This feature allows for continued use of the bed should one of the compartments be punctured or rendered unusable. Top layer 410 may alternatively be a single compartment. In an alternative embodiment, top layer 410 comprises at least two connected compartments that are separated in the middle of top layer 410. This configuration allows for ease in folding bed 400 in half for carrying. Top layer 410 may be constructed with vinyl or other materials that are not liquid permeable and are suitable for holding shape and the weight of the animal.

Bottom layer 420 is configured to receive a heat transfer device to transfer heat from the water in top layer 410, keeping the water cooler and allowing for more efficient transfer of heat from the animal in contact with top layer 410. The heat transfer device may comprise one or more of an ice pack, a gel pack, a refrigerant gel pack, and an endothermic reactive device. In an alternative embodiment, the heat transfer device may be integrated into second layer 420. In this embodiment, mat 400 may be placed in a freezing device to freeze the heat transfer device. In yet another embodiment, second layer 420 may be separable from top layer 410, and second layer 420 may be chilled or frozen before reattaching to top layer 410. The attachment means for second layer 420 to top layer 410 may include, as non-limiting examples, at least one of a zipper, a slider lock, a zip lock, buttons, snaps, and hook and loop, among others.

In an example embodiment, second layer 420 may include a protective layer configured between the heat transfer device and the ground. The protective layer, as a non-limiting example, may be constructed of foam to separate the heat transfer device from the ground. The foam layer may be encapsulated. A protective layer may also be included between top layer 410 and bottom layer 420 in an alternative embodiment.

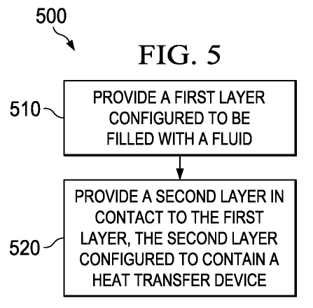

FIG. 5 provides flow chart 500 of a method of providing a pet cooling bed. In block 510, a first layer is provided and configured to be filled with a fluid such as water. In block 520, a second layer is provided in contact with the first layer, and the second layer is configured to comprise a heat transfer device. At least one opening may be provided in the second layer for insertion and removal of the heat transfer device. In an alternative embodiment, the heat transfer device may be provided as integrated into the second layer. In an example embodiment, the second layer may be removably attached to the first layer, and attachment means comprise non-limiting examples of a zipper, a slider lock, a zip lock, buttons, snaps, and hook and loop. Sealing means may be provided for the opening(s) in the second layer comprising non-limiting examples of a zipper, a slider lock, a zip lock, buttons, snaps, and hook and loop. A heat transfer device may be provided in the second layer, the heat transfer device comprising non-limiting examples of an ice pack, a gel pack, a refrigerant gel pack, and an endothermic reactive device.

The example embodiments disclosed herein have been described in relation to a dog in several instances. However, the scope of this disclosure is also applicable to any other animal including configurations suitable for humans. Although the present disclosure has been described in detail, it should be understood that various changes, substitutions and alterations can be made thereto without departing from the spirit and scope of the invention as defined by the appended claims.

Therefore, at least the following is claimed:

1. An apparatus for cooling an animal comprising:
a first top layer configured to hold a fluid; and
a second bottom layer configured to contain at least one heat transfer device for transferring heat from the fluid.

2. The apparatus of claim 1, wherein the first top layer comprises a system of connected compartments.

3. The apparatus of claim 2, wherein the first top layer further comprises an insulative layer on the outside of the connected compartments.

4. The apparatus of claim 1, wherein the second bottom layer comprises at least one opening configured to receive the at least one heat transfer device.

5. The apparatus of claim 4, wherein the at least one opening is sealable with at least one of a zipper, a slider lock, a zip lock, buttons, snaps, and hook and loop.

6. The apparatus of claim 1, wherein the heat transfer device is integrated into the second bottom layer.

7. The apparatus of claim 1, wherein the heat transfer device is at least one of an ice pack, a gel pack, a refrigerant gel pack, and an endothermic reactive device.

8. The apparatus of claim 1, wherein the first top layer further comprises a first larger sealable opening configured for flow of the fluid and a second smaller sealable opening configured for air flow.

9. A method of providing an animal cooling device comprising:
providing a first top layer configured to be filled with a fluid; and
providing a second bottom layer configured to accept a heat transfer device.

10. The method of claim 9, wherein the heat transfer device is integrated into the second bottom layer.

11. The method of claim 10, further comprising providing at least one opening in the second bottom layer for insertion and removal of the heat transfer device.

12. The method of claim 11, further comprising providing sealing means in the at least one opening of the second bottom layer comprising at least one of a zipper, a slider lock, a zip lock, buttons, snaps, and hook and loop.

13. The method of claim 9, wherein the heat transfer device is at least one of an ice pack, a gel pack, a refrigerant gel pack, and an endothermic reactive device.

14. The method of claim 9, wherein providing the first top layer comprises providing a system of connected compartments.

15. The method of claim 9, wherein, the first top layer comprises a plurality of separately fillable compartments.

16. A system for cooling pets comprising:
means for containing a liquid in a first top layer; and
means in a second bottom layer for transferring heat from the liquid.

17. The system of claim 16, wherein then means for containing a liquid in a first top layer comprises a system of connected compartments.

18. The system of claim 16, wherein the second bottom layer comprises at least one opening configured to receive the means for transferring heat from the liquid.

19. The system of claim 18, wherein the at least one opening is sealable with at least one of a zipper, a slider lock, a zip lock, buttons, snaps, and hook and loop.

20. The system of claim 16, wherein the means for transferring heat from the liquid is at least one of an ice pack, a gel pack, a refrigerant gel pack, and an endothermic reactive device.
